(19) United States
(12) Patent Application Publication
(10) Pub. No.: US 2022/0192240 A1
(43) Pub. Date: Jun. 23, 2022

(54) A PROCESS FOR REMOVING GLUCOSE FROM DATES FOR PRODUCING DATES FOR DIET

(71) Applicant: Sami ALSHEHRI, Riyadh (SA)

(72) Inventor: Sami ALSHEHRI, Riyadh (SA)

(21) Appl. No.: 17/603,194

(22) PCT Filed: Apr. 11, 2019
(86) PCT No.: PCT/SA2019/050007

§ 371 Date: Oct. 12, 2021

(51) Int. Cl. A23L 19/00; A23L 33/20; B01D 11/02

(52) U.S. Cl. CPC A23L 19/05; B01D 11/0288; A23L 33/20

(57) ABSTRACT

The invention is related to a processes for producing a new food product of dates free of the glucose, wherein the process of removing the sugars from dates comprises contacting or submerging the dates with a healed water solution, wherein the solution including sodium chloride to remove the sugars from the date fibers; treating the dates fiber by adding food additives such as food coloring, and antioxidants by inhibiting the degradation of food by oxygen.

Dry or soft dates are eaten out-of-hand, or may be pitted and stuffed with fillings such as almonds, walnuts, pecans, candied orange and lemon peel, tahini, marzipan or cream cheese. Pitted dates are also referred to as stoned dates. Partially dried pitted dates tray be glazed with glucose syrup for use as a snack food. Dates can also be chopped and used in a range of sweet and savory dishes, from tajines (tagines) in Morocco to puddings, ka'ak (types of Arab cookies) and other dessert items. Date nut bread, a type of cake, is very popular in the United States, especially around holidays. Dates are also processed into cubes, paste called “ajwa”, spread, date syrup or “honey” called “dibs” or “rub” in Libya, powder (date sugar), vinegar or alcohol. Vinegar made from dates is a traditional product of the Middle East. Recent innovations include chocolate-covered dates and products such as sparkling date juice, used in some Islamic countries as a non-alcoholic version of champagne, for special occasions and religious times such as Ramadan. When Muslims break fast in the evening meal of Ramadan, it is traditional to eat a date first.

Reflecting the maritime trading heritage of Britain, imported chopped dates are added to, or form the main basis of a variety of traditional dessert recipes including sticky toffee pudding, Christmas pudding and date and walnut loaf. They are particularly available to eat whole at Christmas time. Dates are one of the ingredients of HP Sauce, a popular British condiment. Dates can also be dehydrated, ground and mixed with grain to form a nutritious stockfeed.

In Southeast Spain (where a large date plantation exists including UNESCO-protected Palmeral of Elche) dates (usually pitted with fried almond) are served wrapped in bacon and shallow fried.

Dates are one of the ingredients of Jullab, a Middle-Eastern fruit syrup.

Dates provide a wide range of essential nutrients, and are a very good source of dietary potassium. The sugar content of ripe dates is about 80%; the remainder consists of protein, fiber, and trace elements including boron, cobalt, copper, fluorine, magnesium, manganese, selenium, and zinc.

The dates of commerce are the fruit of the species of palm, Phoenix dactylifera. Another species, Phoenix sylvestis, which is very closely related to the date palm, also produces dates. Dates are known to contain high amounts of sugars, amounts ranging as high as 50% to 60% by weight.

Although dates are known to contain large amounts of sugars, the extraction of their sugars has formidable obstacles which have prevented their recovery on a commercial scale. The skins and the cell membranes of dates are tough, and the fruit has a gummy consistency, so that they are not easily broken and subdivided, in order to extract the sugars efficiently.

Many diabetes people can't eat the dates, wherein the dates are known to contain three sugars: fructose, sucrose and glucose. In the past, attempts to extract sucrose, fructose and glucose from plant materials simultaneously has not been commercially successful. It has been the custom in the extraction and purification of sucrose to single out sucrose individually, and to treat the fructose and glucose as impurities, and not to recover them. In plants containing a high percentage of fructose, it has been difficult to recover the fructose singularly, because of other impurities. Thus, plants containing a predominance of fructose, such as oranges or grapes, are sold without processing them for supplying the fructose for human consumption. In the case of grapes, the fructose is processed into alcohol for a greater financial return.

As indicated above, dates are difficult to comminute, as by grinding, pulverizing, chopping or slicing, because of their tough skin and cell walls, and their gummy consistency. For this reason, they are most often sold and used as articles of commerce as the intact fruit, pitted, or unpitted. The several other parts of dates, however, also may yield products of value to the area where they are grown. The seeds, or pits, for example, are sometimes ground and used for feed stock. The stems of a small species Phoenix farinifera are sometimes processed to make a date palm meal.

U.S. Pat. No. 5,853,488 relates to processes for extracting sugars from dates, and for making novel food products.

### GENERAL DESCRIPTION

The invention relates to a a processes for producing a new food product of dates free of the glucose, wherein the process of removing the sugars from dates comprises contacting or submerging the dates with a heated water solution, wherein the solution including sodium chloride to remove the sugars from the date fibers; treating the dates fiber by adding food additives such as food coloring, and antioxidants by inhibiting the degradation of food by oxygen.

Another aspect of the invention relates to a method for producing a new food product of dates free of the three sugars, fructose, sucrose and glucose, wherein the process of removing the sugars from dates comprises contacting or submerging the dates with a heated water solution, wherein the solution including sodium chloride to remove the sugars from the date fibers; treating the dates fiber by adding food additives such as food coloring, and antioxidants by inhibiting the degradation of food by oxygen.

### BRIEF DESCRIPTION OF THE DRAWINGS

FIG. 1 is a drawing showing the units of process;

FIG. 2 is a prospective view shows the bottom of the processer unit;

FIG. 3 is a cross-sectional view of the processer unit;

FIG. 4 is a test results of the chemical analysis of the date before the process;

FIG. 5 is a test results of the chemical analysis of the date after the process;

### DETAILED DESCRIPTION

The present invention is related to a a processes for producing a new food product of dates free of the glucose, wherein the process of removing the sugars from dates comprises contacting or submerging the dates with a heated water solution, wherein the solution including sodium chloride to remove the sugars from the date fibers; treating the dates fiber by adding food additives such as food coloring, and antioxidants by inhibiting the degradation of food by oxygen; wherein the process comprises water tanks; refrigerators to store raw materials (dates) before processing; a main processing unit which is able to heat the water; sieves and screens to separate the dates from the solution after treatment; conveyor belts to move the date from the processing unit to the cooling unit; means to take sample and analyze the product and show the percentage of the sugar extraction; drying oven; refrigerators to store the new products.

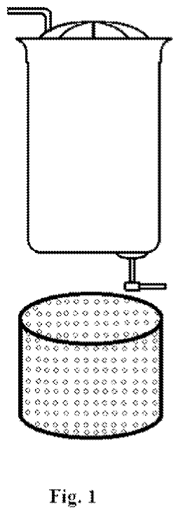

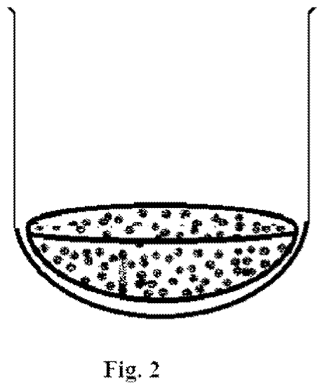

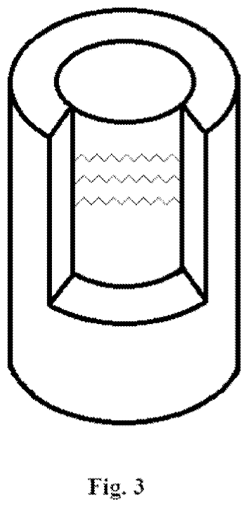

FIG. 1 shows that the process comprises that a process means where the dates are contacted or immersed with a heated water solution, wherein the water temperature is from 70° C. to 80° C. and the water solution comprises 1 L for each 0.5 of the date; 20 mg to 50 mg from the sodium chloride; food additives such as food coloring, and antioxidants.

The process of removing the glucose from the dates comprises:

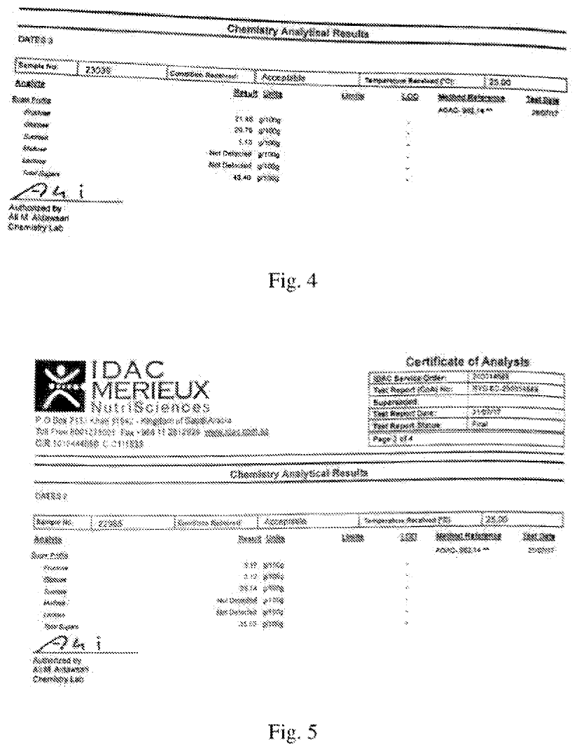

analyzing a sample of the dates to obtain the chemical analyzing results as shown in FIG. 4 to determine the contents of glucose in the certain type of dates;

contacting or immersing the dates in hot water in a temperature between 70° C. to 80° C; for 15 minutes to 20 minutes at least once depend on the type of dates;

analyzing a sample of the treated dates to obtain the chemical analyzing results as shown in FIG. 5 to determine the contents of glucose in the treated dates, and if the results show the acceptable contents of the glucose, the products shall be proceeded, otherwise, the said dates shall be returned to the process;

sorting the treated dates by size, weight, and the same is moved on the conveyer belts;

drying the treated dates in an oven, wherein the drying should be performed carefully to avoid vulnerable and exposed to damage; and

storing the treated dates into refrigerators.

1. A process for producing a new food product of dates free of the glucose comprises analyzing a sample of the dates to obtain the chemical analyzing results to determine the contents of glucose in the certain type of dates;
contacting or immersing the dates in hot water at a temperature of water is between 70° C. to 80° C.;
analyzing a sample of the treated dates to obtain the chemical analyzing results to determine the contents of glucose in the treated dates;
immersing the dates for 15 minutes to 20 minutes at least once depend on the type of dates. sorting the treated dates by size, weight, and the same is moved on the conveyer belts;
drying the treated dates in an oven; and
storing the treated dates into refrigerators.

2. The process of claim 1, wherein the drying should be performed carefully to avoid vulnerable and exposed to damage.

3. A diet dates produced by a process of claim 1.
